(19) United States
(12) Patent Application Publication
(10) Pub. No.: US 2017/0266669 A1
(43) Pub. Date: Sep. 21, 2017

(54) PICK WITH LIMITED TAPERED ENGAGEMENT

(71) Applicant: Joy MM Delaware, Inc., Wilmington, DE (US)

(72) Inventors: Brett W. Rhea, Georgetown, KY (US); Charles M. Anderson, JR., Paris, KY (US); Joshua A. Fuhr, Cynthiana, KY (US); Charles W. Watson, Paris, KY (US); William Harney, Millersburg, KY (US); Jarrod Elliott, Augusta, KY (US)

(21) Appl. No.: 15/612,767

(22) Filed: Jun. 2, 2017

Related U.S. Application Data
(63) Continuation-in-part of application No. 14/203,810, filed on Mar. 11, 2014, now Pat. No. 9,724,701.
(60) Provisional application No. 61/777,375, filed on Mar. 12, 2013.
(60) Provisional application No. 62/345,361, filed on Jun. 3, 2016.

(51) Int. Cl. B02C 13/28; B02C 13/286; B02C 13/06

(52) U.S. Cl. CPC B02C 13/2804; B02C 13/06; B02C 13/286

(57) ABSTRACT

A pick system includes a holder and a pick assembly. The holder includes a first end, a second end, and a bore extending between the first end and the second end and defining a longitudinal axis. The surface of the bore may be tapered so that the diameter of the bore proximate the first end is greater than the diameter of the bore proximate the second end. The pick assembly includes a shaft. The shaft is received within the bore of the holder along the longitudinal axis, and the shaft may be tapered to mate with the bore.

### CROSS-REFERENCE TO RELATED APPLICATIONS

This application is a continuation-in-part of U.S. patent application Ser. No. 14/203,810, filed Mar. 11, 2014, which claims the benefit of U.S. Provisional Patent Application No. 61/777,375, filed Mar. 12, 2013. This application also claims the benefit of prior-filed, co-pending U.S. Provisional Patent Application No. 62/345,361, filed Jun. 3, 2016. The entire contents of each of these documents are hereby incorporated by reference.

### FIELD

The present disclosure relates to rotating drum crushers and cutters, and particularly to a pick system for a rotating drum (e.g., for a feeder breaker).

### SUMMARY

Feeder breakers engage and break apart cut material. Typically, a feeder breaker is positioned adjacent a conveyor carrying the material. A feeder breaker may include an axle, a drum supported by and rotatable with the axle, and holders positioned on an exterior surface of the drum. Each holder supports a pick (or an intermediate holder that supports a pick) that engages and breaks the material on the conveyor to reduce the material to a predetermined size.

A conventional holder includes a straight bore that receives a shank of an intermediate holder. The shank is inserted into the bore from one end and secured at the opposite end by a threaded nut. A spacer ring is positioned in the bore between the holder and the shank. As the breaker engages the material, the impact force of the material against the pick is absorbed by the front face of the holder around the bore from the intermediate holder. Over time, the holder's face may become distorted and cause the intermediate holder to become loose, which may cause the impact forces to shear the shank of the intermediate holder.

In one embodiment, the invention provides a pick system including a holder and a pick assembly. The holder includes a first end, a second end, and a bore extending between the first end and the second end and defining a longitudinal axis. The surface of the bore may be tapered so that the diameter of the bore proximate the first end is greater than the diameter of the bore proximate the second end. The pick assembly includes a shaft. The shaft is received within the bore of the holder along the longitudinal axis, and the shaft may be tapered to mate with the bore.

In another embodiment, the invention provides a feeder breaker for processing cut material. The feeder breaker includes a conveyor and a breaker for engaging the cut material. The conveyor includes a first end for receiving material and a second end for discharging material. The breaker is positioned between the first end and the second end of the conveyor. The breaker includes a drum rotatably supported on an axle and a plurality of pick systems positioned circumferentially around the drum. Each pick system includes a holder and a pick assembly. The holder has a first end and a second end and defines a bore extending between the first end and the second end along a longitudinal axis. A surface of the bore is tapered with a diameter of the bore proximate the first end being greater than a diameter of the bore proximate the second end. The pick assembly includes a shaft received within the bore of the holder along the longitudinal axis. The shaft is tapered to mate with the bore.

In yet another embodiment, the invention provides a method of manufacturing a pick system for a breaker including a drum rotatable about a drum axis and having an outer surface. The method includes forming a pick holder having a first end and a second end, securing the pick holder to the outer surface of the drum, inserting a pick assembly into the first end of the bore, and securing the pick assembly relative to the holder. The pick holder defines a bore extending between the first end and the second end along a longitudinal axis. Forming includes forming a surface of the bore to be tapered with a diameter of the bore proximate the first end being greater than a diameter of the bore proximate the second end. The pick assembly includes a tapered shaft that mates with the bore.

In still another embodiment, a pick system includes a holder and a pick. The holder includes a first end, a second end, and a bore extending at least partially between the first end and the second end along a longitudinal axis. The bore is tapered and has a bore taper angle relative to the longitudinal axis such that a diameter of a portion of the bore proximate the first end is greater than a diameter of a portion of the bore proximate the second end. The pick includes a shaft, a cutting end, and a shoulder positioned between the shaft and the cutting end. The shaft is tapered and has a shaft taper angle substantially equal to the bore taper angle. The shoulder abuts the first end of the holder to limit an insertion depth of the shaft and therefore limit a maximum engagement between the shaft and the bore.

In yet another embodiment, a feeder breaker includes a conveyor and a breaker. The conveyor includes a first end for receiving material and a second end for discharging the material. The breaker engages the material and is positioned between the first end and the second end of the conveyor. The breaker includes a drum rotatably supported on an axle and a plurality of pick systems secured to an outer surface of the drum. At least one pick system includes a holder and a pick. The holder includes a first end, a second end, and a bore extending at least partially between the first end and the second end along a longitudinal axis. The bore has a bore taper angle such that a diameter of a portion of the bore proximate the first end is greater than a diameter of a portion of the bore proximate the second end. The pick includes a shaft, a cutting end, and a shoulder positioned between the shaft and the cutting end. The shaft has a shaft taper angle substantially equal to the bore taper angle. The shoulder abuts the first end of the holder to limit an insertion depth of the shaft and therefore limit a maximum engagement between the shaft and the bore.

In still another embodiment, a method is provided for forming a pick system for a breaker including a drum rotatable about a drum axis and having an outer surface. The method includes: securing a plurality of pick holders to the outer surface of the drum, each pick holder including a first end, a second end, and a bore extending at least partially between the first end and the second end along a longitudinal axis, the bore having a tapered inner surface such that a diameter of the bore proximate the first end is greater than a diameter of the bore proximate the second end; positioning a shaft of a pick within the bore such that a tapered surface of the shaft mates with the bore and a shoulder of the shaft is spaced apart from the first end of the holder by a gap; and inserting the shaft of the pick into the bore until the shoulder abuts the first end of the holder.

Other independent aspects will become apparent by consideration of the detailed description and accompanying drawings.

### BRIEF DESCRIPTION OF THE DRAWINGS

FIG. 1 is a perspective view of a breaker assembly.

FIG. 2 is a partially exploded perspective view of a breaker.

FIG. 3 is a side view of the breaker of FIG. 2.

FIG. 4 is an enlarged exploded view of the breaker of FIG. 2.

FIG. 5 is an exploded side view of a pick system.

FIG. 6 is a cross-section view of the pick system of FIG. 5.

FIG. 7 is an enlarged exploded view of a breaker including a pick system according to another embodiment.

FIG. 8 is a cross-section view of the pick system of FIG. 7 with a pick in a first position.

FIG. 9 is a cross-section view of the pick system of FIG. 7 with the pick in a second position.

FIG. 10 is a cross-section view of a pick system according to yet another embodiment, with a pick in a first position.

FIG. 11 is a cross-section view of the pick system of FIG. 10 with the pick in a second position.

Before any independent embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting

Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof. Unless specified or limited otherwise, the terms “mounted,” “connected,” “supported,” and “coupled” and variations thereof are used broadly and encompass both direct and indirect mountings, connections, supports, and couplings.

### DETAILED DESCRIPTION

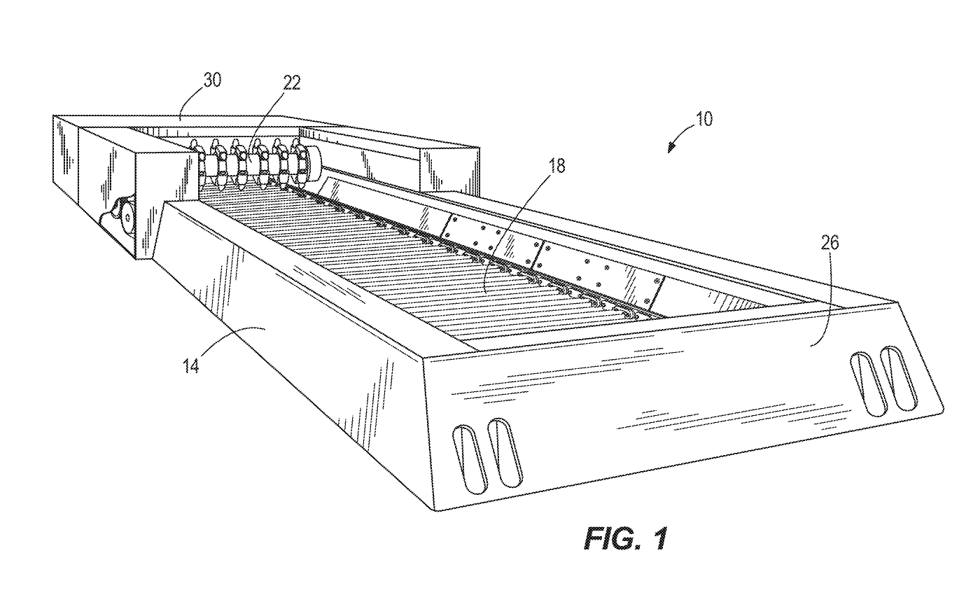

FIG. 1 illustrates a material crushing and sizing mechanism (e.g., a feeder breaker 10) that processes material, such as coal, to a predetermined size and conveys the material. The feeder breaker 10 includes a frame 14, a conveyor 18, and a breaker 22. The conveyor 18 moves material from an intake end 26 to a discharge end 30, and the breaker 22 is positioned between the intake end 26 and the discharge end 30.

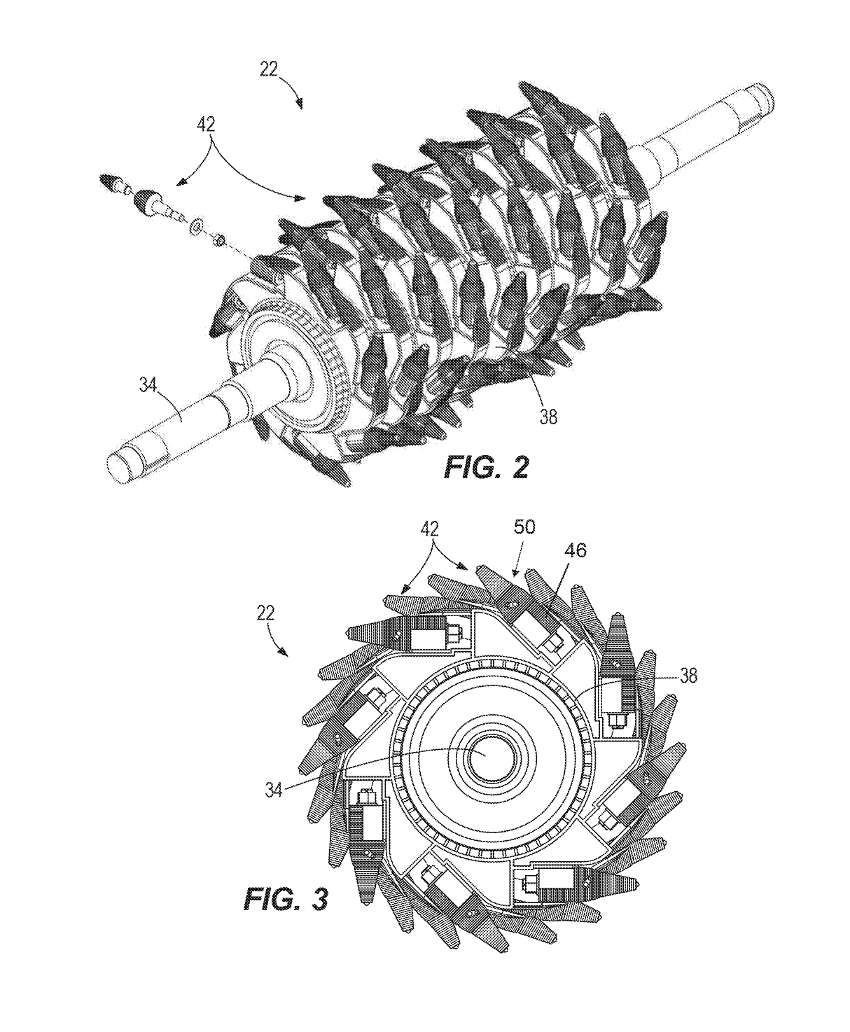

FIGS. 2 and 3 illustrate the breaker 22. The breaker 22 includes an axle 34, a drum 38 supported by the axle 34 for rotation with the axle 34, and pick systems 42 secured to an outer portion of the drum 38. In the illustrated embodiment, the pick systems 42 are oriented along a tangent to the outer profile of the drum 38. Each pick system 42 includes a holder 46 and a material engaging tool or pick assembly 50 received within the holder 46. In the illustrated embodiment, the holder 46 is welded to the drum 38, and each of the holders 46 includes an exterior surface having ribs (e.g., formed by weld lines). In other embodiments (not shown), the structure of the holder 46 may be different or the holder 46 may be coupled to the breaker 22 in a different way (e.g., fasteners), as desired.

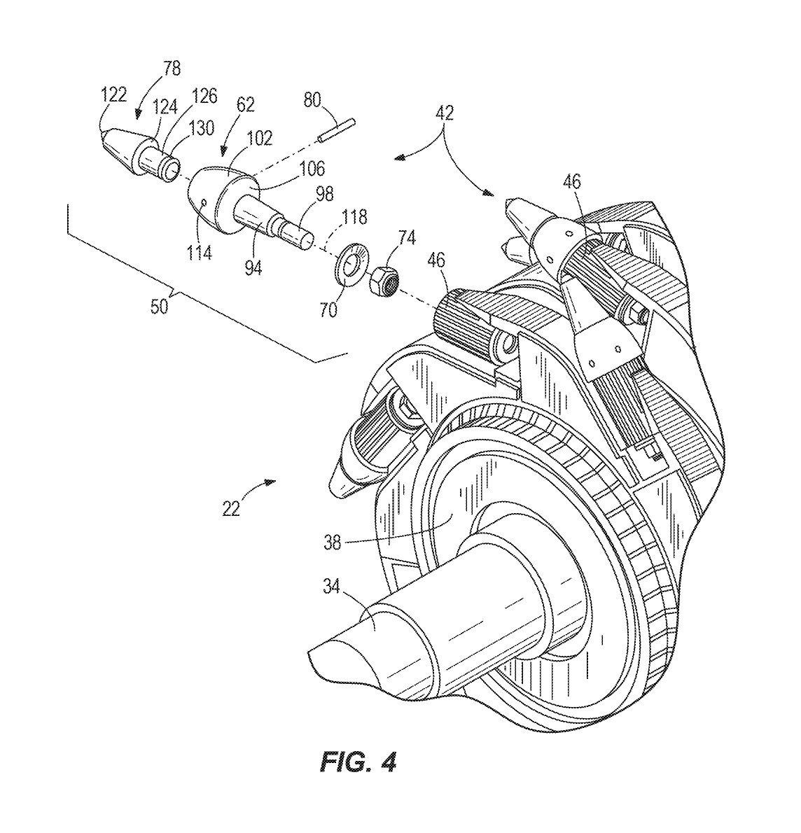

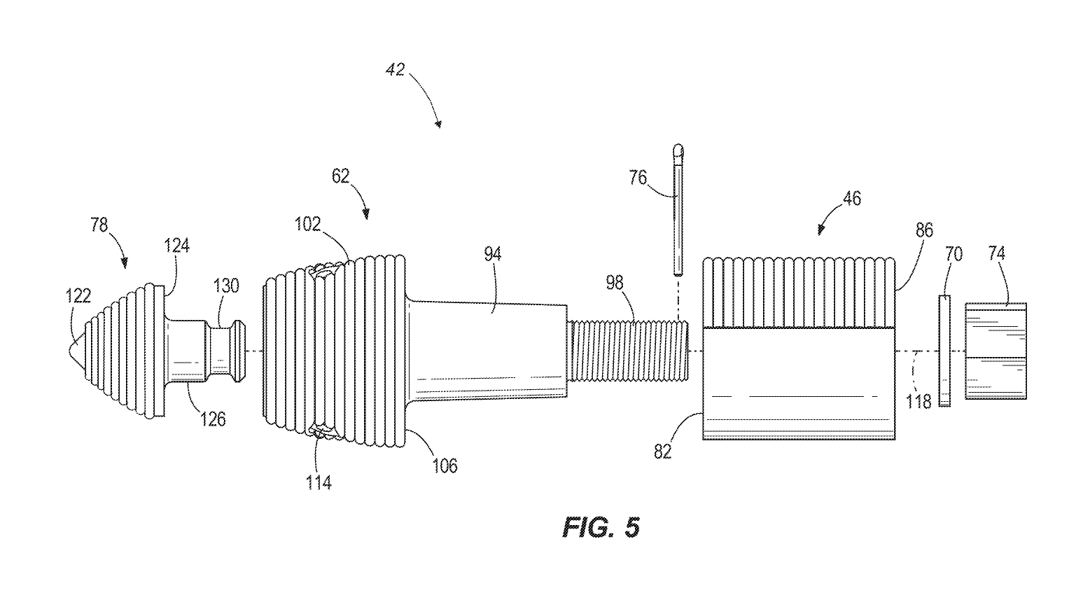

As shown in FIG. 4, in the illustrated embodiment, the pick assembly 50 includes an intermediate holder 62, a washer 70, a nut 74, a locking pin 76 (FIG. 5), a breaker pick 78, and a pin 80. The pick assembly 50 is coupled to the holder 46 along a longitudinal axis 118, and the breaker pick 78 forms an end or point 122 for engaging material. The pick assembly 50 includes replaceable parts facilitating simple and easy removal and replacement of the material engaging components (e.g., the breaker pick 78, the intermediate holder 62, etc.).

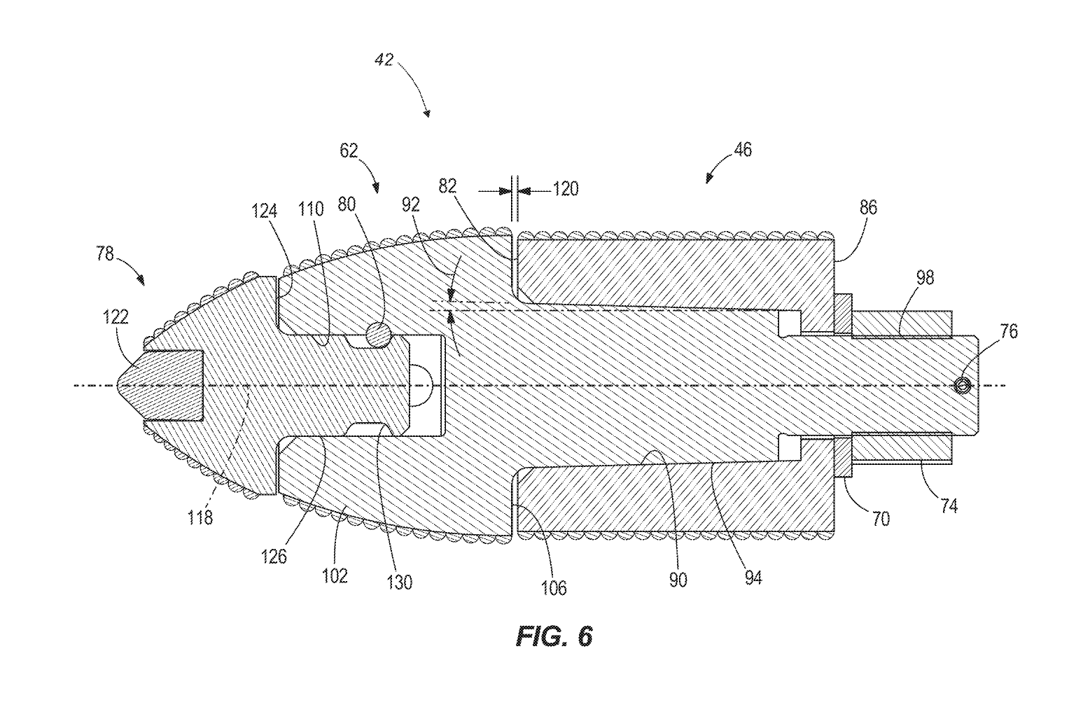

Referring to FIGS. 5 and 6, the holder 46 has a first end 82 and a second end 86 and defines a bore 90 (FIG. 6) extending between ends 82, 86. As best shown in FIG. 6, the bore 90 tapers from the first end 82 to the second end 86, so that the diameter of the bore 90 proximate the first end 82 is larger than the diameter of the bore 90 proximate the second end 86. In the illustrated embodiment, the bore 90 forms a continuous, inclined taper substantially between the first end 82 to the second end 86. The tapered bore 90 forms an angle 92 relative to the longitudinal axis 118. In the illustrated embodiment, the angle 92 is approximately 1.493 degrees. In other embodiments, the angle may be between approximately one and two degrees relative to the longitudinal axis 118. In still other embodiments, the angle may be between approximately 0.5 degrees and ten degrees relative to the longitudinal axis 118.

As shown in FIGS. 4-6, the intermediate holder 62 includes a shank or shaft 94, a threaded end portion 98, a body portion 102, and a shoulder 106 between the shaft 94 and the body portion 102. A pick opening 110 (FIG. 6) is formed on an end of the body portion 102 and is configured to receive the breaker pick 78. A pin aperture 114 (FIG. 4) is formed in the body portion 102 and is transverse to and offset from the longitudinal axis 118 of the pick assembly 50. In the illustrated embodiment, the shaft 94 forms a continuous surface without any slots or breaks, and the shaft 94 is tapered in a manner that is substantially identical to the tapered surface of the bore 90. That is, in the illustrated embodiment, the tapered shaft 94 forms an angle relative to the longitudinal axis 118 that is substantially equal to the angle 92. The shaft 94 substantially mates with the bore 90 while forming a space 120 between the first end 82 of the holder 46 and the shoulder 106. In one embodiment, the space 120 is between approximately 0.0625 inches and 0.125 inches (one-sixteenth of an inch to one-eighth of an inch). In other embodiments, the space may be between approximately 0.090 inches and 0.120 inches.

The breaker pick 78 includes a mining point 122, a pick shoulder 124 transitioning to a pick shaft 126, and a pin receiving feature in the form of a groove or a pin recess 130 formed in the shaft 126. The pick shaft 126 is sized to be received within the pick opening 110 of the intermediate holder 62. Further, the pin recess 130 is positioned on the pick shaft 126 such that when the breaker pick 78 is installed in the intermediate holder 62, the pin recess 130 is aligned with the pin aperture 114 (FIG. 4). In other constructions (not shown), the pin receiving feature could be an aperture, a depression, a blind hole, or another feature, as desired.

In the illustrated embodiment, the pin 80 is a coiled spring pin, and both the pin 80 and the pin aperture 114 are sized such that the pin 80 is retained by friction within the pin aperture 114. In the illustrated embodiment, the pin 80 is made from stainless steel. The pin material resists reaction loads and shear failures that result from the impacts that the breaker pick 78 absorbs during normal use. In other embodiments (not shown), other suitable materials may be used or the pin aperture 114 and the pin 80 may be a different shape (e.g., square, rectangular, oval), as desired.

The pick assembly 50 is installed by first inserting the shaft 94 of the intermediate holder 62 into the holder 46 such that the shoulder 106 faces the first end 82 of the holder 46. With the intermediate holder 62 positioned in the holder 46, one or more washers 70 are aligned and installed on the shaft 94 of the intermediate holder 62 proximate the second end 86. The nut 74 is then threaded onto the threaded end portion 98 of the intermediate holder 62. The nut 74 is tightened to a desired torque and/or until the washer(s) 70 are compressed or flattened to a desired thickness. Preferably, this tightness is applied by a torque wrench to prevent over-tightening. The washer 70 acts in cooperation with the nut 74 to inhibit the nut 74 from unthreading (i.e., loosening). The locking pin 76 (FIG. 5) is inserted through at least a portion of the threaded end portion 98 to secure the nut 74 and washer 70 on the threaded end portion 98. In the illustrated embodiment, the locking pin 76 is a cotter pin.

Once the intermediate holder 62 is tightened and secured within the holder 46, the pick shaft 126 of the breaker pick 78 is inserted into the pick opening 110 such that the recess 130 aligns with the pin aperture 114. The pin 80 is inserted into the pin aperture 114 and into the recess 130 of the breaker pick 78 so that the pin 80 is engaged between the body portion 102 of the intermediate holder 62 and the breaker pick 78. Such positive engagement holds the breaker pick 78 securely in position, while the pin 80 remains within the pin aperture 114.

To remove the breaker pick 78, the above installation process is reversed. The pin 80 is pushed out of the pin aperture 114 and therefore out of engagement with the breaker pick 78. Once the used breaker pick 78 is removed, a new breaker pick 78 may be reinserted into the intermediate holder 62.

The pick assembly 50 provides a system for replacing breaker picks on feeder breakers with relatively simple tooling. Also, the tapered shaft 94 provides a larger surface area for distributing stress from the impact loads, which may prevent the stress from being concentrated around the first end 82 of the holder 46. In addition, the tapered bore 90 and shaft 94 eliminate the need for a spacer ring, which may reduce the likelihood of shear failure caused by the spacer ring becoming distorted during operation.

Furthermore, in the illustrated embodiment, if the nut 74 were to become loose during operation, the intermediate bit holder 62 would re-seat itself within the bore 90 during the subsequent impact. As a result, the stress would continue to be distributed among the tapered surfaces, which may reduce wear on the intermediate holder 62 and extend the life of the pick assembly 50. These and other independent advantages may lead to savings and physical advantages for the end user. When installed, the breaker pick system 50 does not penalize machine performance and may provide an added benefit for the end user.

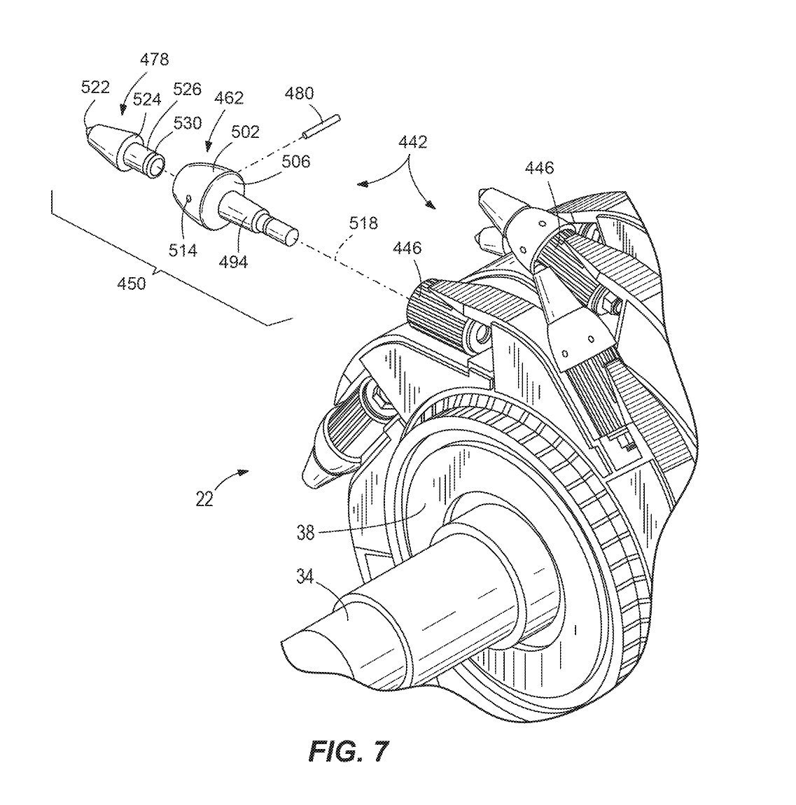

FIGS. 7-9 illustrate a pick system 442 according to another embodiment. The pick system 442 is similar to the pick system 42 described above with respect to FIGS. 4-6, and similar features are identified with similar reference numbers, plus 400. For sake of brevity, differences between the pick system 42 and the pick system 442 will primarily be described.

As shown in FIG. 7, in the illustrated embodiment, the pick system 42 includes a pick assembly 450 including an intermediate holder 462, a breaker pick 478, and a pin 480. The pick assembly 450 is coupled to the holder 446 along a longitudinal axis 518, and the breaker pick 478 forms an end or point 522 for engaging material. The pick assembly 450 facilitates simple and easy removal and replacement of the material engaging components (e.g., the breaker pick 478, the intermediate holder 462, etc.).

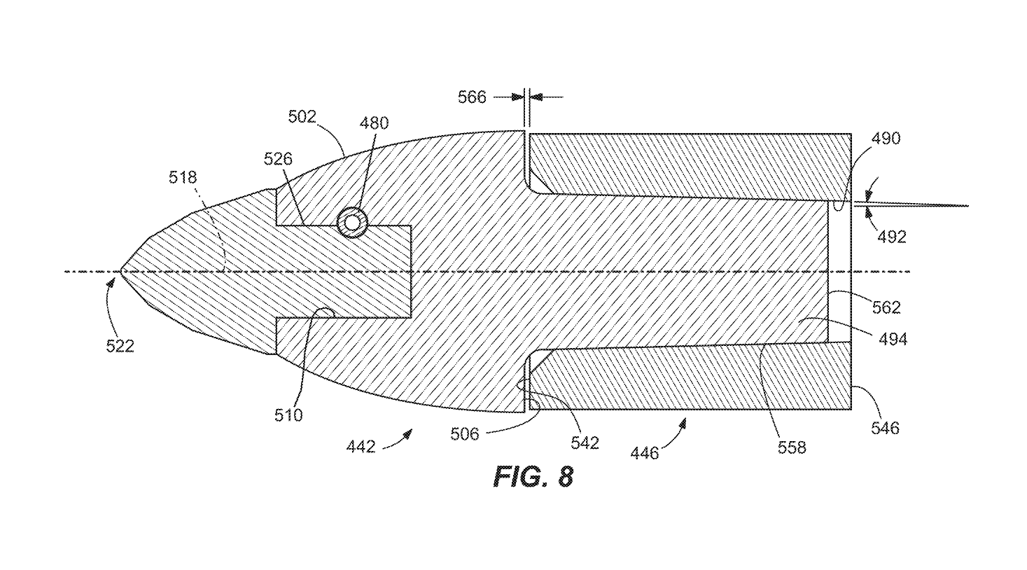

In one embodiment, the intermediate holder 462 includes a shank 494, body 502, a shoulder 506, and an aperture 514 for receiving the pin 480. The shank 494 is received within a bore 490 (FIG. 8) of the holder 446. The breaker pick 478 includes a pick shoulder 524 and a pick shank 526. In the illustrated embodiment, the pick shank 526 is received in a pick opening 510 (FIG. 8) of the body 502 of the intermediate holder 462. The shank 526 of the breaker pick 478 includes a groove 530 for receiving the pin 480, which secures the breaker pick 478 relative to the intermediate holder 462.

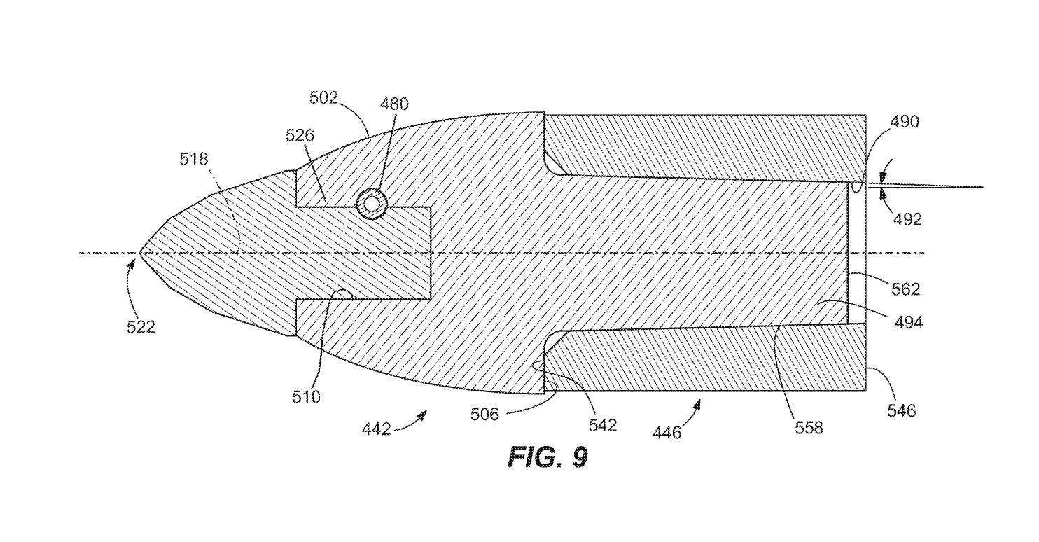

FIGS. 8 and 9 illustrate the pick assembly 450 positioned within the holder 446. The holder 446 includes a first end 542, a second end 546, and a bore 490 extending between ends 542, 546. The bore 490 tapers from the first end 542 to the second end 546 such that the diameter of the bore 490 proximate the first end 542 is larger than the diameter of the bore 90 proximate the second end 546. In the illustrated embodiment, the bore 490 forms a continuous, inclined taper between the first end 542 to the second end 546. The tapered bore 490 forms a taper angle 492 (FIG. 8) relative to the longitudinal axis 518. In the illustrated embodiment, the taper angle 492 is approximately 1.5 degrees. In some embodiments, the angle 492 is less than approximately 7 degrees in order to provide a self-holding taper engagement between the shank 494 and the bore 490. In some embodiments, the taper angle 492 may be between approximately one and two degrees relative to the longitudinal axis 518.

FIG. 8 illustrates the pick assembly 450 in an initial position relative to the holder 446. The shank 494 includes an outer surface 558 that has a taper between the shoulder 506 and an end 562 of the shank 494, such that a portion of the shank 494 proximate the shoulder 506 has a larger diameter than a portion of the shank 494 proximate the end 562. The outer surface of the shank 494 tapers at an angle that is substantially equal to the taper angle 492 of the bore 490.

In the initial position illustrated in FIG. 8, a clearance gap 566 is formed between the shoulder 506 and the first end 542 of the holder 446. In other embodiments, the gap 566 may be larger or smaller than the gap 566 illustrated in FIG. 8. Once in position, the pick assembly 450 is then seated within the holder 446 by inserting the pick assembly 450 to a desired depth within the holder 446. Seating may be accomplished in various ways, such as by applying an impact force on the pick assembly 450 (e.g., by a hammer), pressing the pick assembly 450 in the bore 490, or pulling the pick assembly 450 relative to the holder 446. When seated, the pick assembly 450 is retained by a contact pressure between the tapered surfaces of the bore 490 and the shank 494. The contact pressure increases depending on the depth of engagement between the shank 494 and the bore 490. As shown in FIG. 9, the shoulder 506 provides a stop surface to prevent insertion of the pick assembly 450 beyond a predetermined point. The shoulder 506 therefore limits the maximum contact pressure that can be exerted between the shank 494 and the bore 490. As a result, a user can remove the pick assembly 450 using basic tools. The pick assembly 450 may be dislodged and removed using various methods, including hammering, pressing, pulling, and/or wedging between the shoulder 506 and the first end 542 of the holder 446.

An issue with existing feeder breakers is the lack of a defined or set contact pressure between the bore 490 and the shank 494. As a result, the pick and the holder are subject to either 1) a lack of sufficient engagement, or 2) excessive engagement. Lack of sufficient engagement results in the pick not being secured within the bore 490 and becoming dislodged during normal operation. Excessive engagement, on the other hand, results in large contact pressure between the pick assembly and the holder 446, making it difficult (or in some cases, impossible) to remove the pick assembly in a timely manner. This significantly increases the time required to replace or repair the picks, which reduces the production time of the feeder breaker 10. In addition, operation of the feeder breaker 10 typically drives the pick assembly inwardly into the bore 490, further wedging the shank within the bore 490. This is particularly true for picks that are installed with a gap or space between the pick and the holder 446.

The pick assembly 450 described above incorporates a tapered shank 494 to insure a minimum engagement (and therefore a minimum contact pressure) with the bore 490. Similarly, the shoulder 506 abuts the first end 542 of the holder 446 to limit the insertion of the shank 494 relative to the bore 490, thereby limiting the maximum engagement or contact pressure. The loads exerted on the pick assembly 450 are transmitted to the drum primarily through the contact between the shoulder 506 and annular surface of the first end 542 of the holder 446.

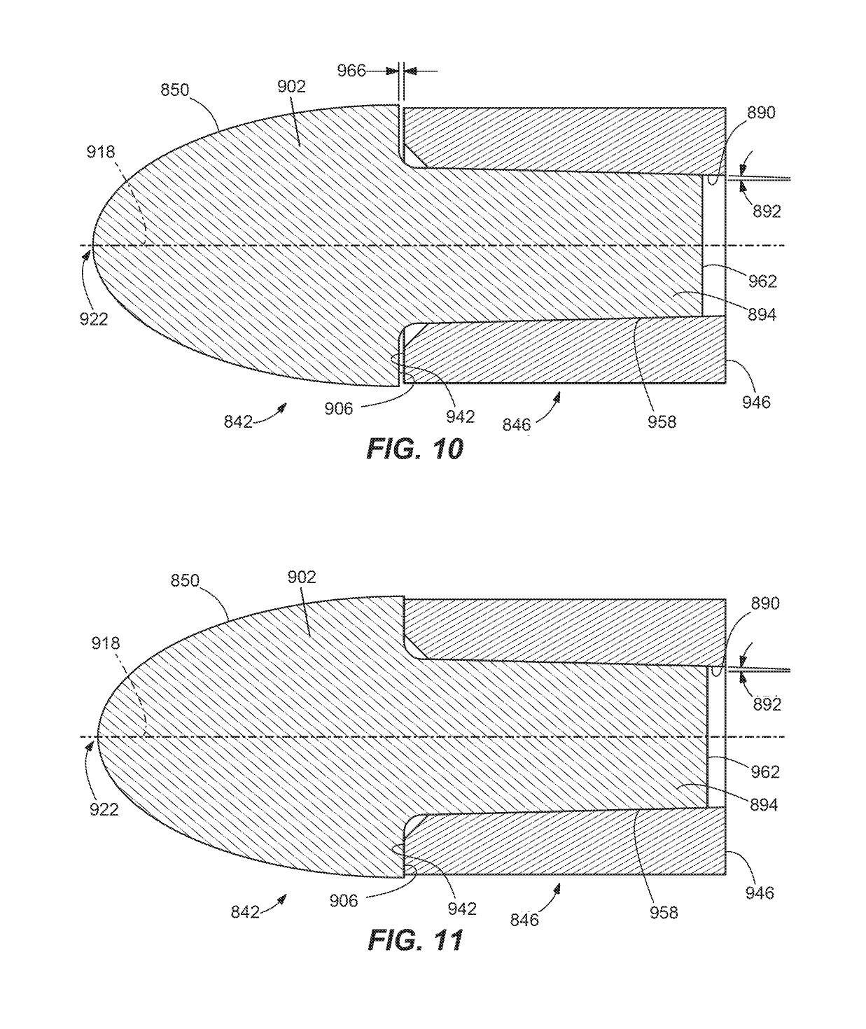

FIGS. 10 and 11 illustrate a pick system 842 according to yet another embodiment. The pick system 842 is similar to the pick system 442 described above with respect to FIGS. 7-9, and similar features are identified with similar reference numbers, plus 400.

The pick system 842 includes a unitary pick 850 coupled to a holder 846 along a longitudinal axis 918, and the pick 850 forms an end or point 922 for engaging material. In one embodiment, the pick 850 includes a shank 894, a body 902, and a shoulder 906. The shank 894 is received within a bore 890 of the holder 846, the bore 890 extending between ends 942, 946. The bore 890 tapers from the first end 942 to the second end 946 such that the diameter of the bore 890 proximate the first end 942 is larger than the diameter of the bore 890 proximate the second end 946.

FIG. 10 illustrates the pick 850 in an initial position relative to the holder 846. The shank 894 includes an outer surface 958 that has a taper between the shoulder 906 and an end 962 of the shank 894, such that a portion of the shank 894 proximate the shoulder 906 has a larger diameter than a portion of the shank 894 proximate the end 962. The outer surface 958 of the shank 894 tapers at an angle that is substantially equal to the taper angle 892 of the bore 890.

In the position illustrated in FIG. 10, a clearance gap 966 is formed between the shoulder 906 and the first end 942 of the holder 846. In other embodiments, the gap 966 may be larger or smaller than the gap 966 illustrated in FIG. 10. Once in position, the pick 850 is seated (e.g., applying an impact force on the pick 850, pressing the pick 850, or pulling the pick 850 relative to the holder 846) within the holder 846 by inserting the pick 850 to a desired depth. The pick 850 is retained by a contact pressure between the tapered surfaces of the bore 890 and the shank 894. As shown in FIG. 11, the shoulder 906 provides a stop surface to prevent insertion of the pick assembly 850 beyond a predetermined point, therefore limiting the maximum contact pressure that can be exerted between the shank 894 and the bore 890. The pick 850 may be dislodged and removed using various methods (e.g., hammering, pressing, pulling, and/or wedging between the shoulder 906 and the first end 942 of the holder 846).

Although the pick systems 42, 442, 842 have been described above in the context of a feeder breaker 10, it is understood that the pick systems 42, 442, 842 can be incorporated into other machines that include a rotating drum crusher or cutter. For example, in addition to feeder breakers, the pick systems 42, 442, 842 could be implemented on a double roll crusher, a continuous miner cutter head, and other types of cutting mechanisms.

Although aspects have been described in detail with reference to certain preferred embodiments, variations and modifications exist within the scope and spirit of one or more independent aspects as described. Various features and advantages are set forth in the following claims.

What is claimed is:

1. A pick system comprising
a holder including a first end, a second end, and a bore extending at least partially between the first end and the second end along a longitudinal axis, the bore being tapered and having a bore taper angle relative to the longitudinal axis such that a diameter of a portion of the bore proximate the first end is greater than a diameter of a portion of the bore proximate the second end; and
a pick including a shaft, a cutting end, and a shoulder positioned between the shaft and the cutting end, the shaft being tapered and having a shaft taper angle substantially equal to the bore taper angle, the shoulder abutting the first end of the holder to limit an insertion depth of the shaft and therefore limit a maximum engagement between the shaft and the bore.

2. The pick system of claim 1, wherein the pick includes an intermediate pick holder and a breaker pick coupled to the intermediate pick holder, the shaft being formed on the intermediate pick holder, the cutting end formed on the breaker pick.

3. The pick system of claim 2, wherein the breaker pick is coupled to the intermediate pick holder by a pin.

4. The pick system of claim 1, wherein the pick includes a unitary pick, the shaft and the cutting end being integrally connected to one another.

5. The pick system of claim 1, wherein the bore extends through the second end of the holder such that the second end is open.

6. The pick system of claim 1, wherein the bore taper angle is between approximately 0.5 degrees and approximately ten degrees.

7. The pick system of claim 6, wherein the bore taper angle is between approximately 0.5 degrees and approximately seven degrees.

8. A feeder breaker comprising:
a conveyor including a first end for receiving material and a second end for discharging the material; and
a breaker for engaging the material, the breaker being positioned between the first end and the second end of the conveyor, the breaker including a drum rotatably supported on an axle and a plurality of pick systems secured to an outer surface of the drum, at least one pick system including
a holder including a first end, a second end, and a bore extending at least partially between the first end and the second end along a longitudinal axis, the bore having a bore taper angle such that a diameter of a portion of the bore proximate the first end is greater than a diameter of a portion of the bore proximate the second end, and
a pick including a shaft, a cutting end, and a shoulder positioned between the shaft and the cutting end, the shaft having a shaft taper angle substantially equal to the bore taper angle, the shoulder abutting the first end of the holder to limit an insertion depth of the shaft and therefore limit a maximum engagement between the shaft and the bore.

9. The feeder breaker of claim 8, wherein the pick assembly includes an intermediate pick holder and a breaker pick coupled to the intermediate pick holder, the shaft being formed on the intermediate pick holder, the cutting end formed on the breaker pick.

10. The feeder breaker of claim 9, wherein the breaker pick is coupled to the intermediate pick holder by a pin.

11. The feeder breaker of claim 8, wherein the bore extends through the second end of the holder such that the second end is open.

12. The feeder breaker of claim 8, wherein the bore taper angle is between approximately 0.5 degrees and approximately ten degrees.

13. The feeder breaker of claim 12, wherein the bore taper angle is between approximately 0.5 degrees and approximately seven degrees.

14. A method of forming a pick system for a breaker, the breaker including a drum rotatable about a drum axis and having an outer surface, the method comprising:
securing a plurality of pick holders to the outer surface of the drum, each pick holder including a first end, a second end, and a bore extending at least partially between the first end and the second end along a longitudinal axis, the bore having a tapered inner surface such that a diameter of the bore proximate the first end is greater than a diameter of the bore proximate the second end;
positioning a shaft of a pick within the bore such that a tapered surface of the shaft mates with the bore and a shoulder of the shaft is spaced apart from the first end of the holder by a gap; and
inserting the shaft of the pick into the bore until the shoulder abuts the first end of the holder.

15. The method of claim 14, wherein positioning the shaft includes positioning a shaft of an intermediate pick holder within the bore, and further comprising coupling a breaker pick to an end of the intermediate pick holder opposite the shaft.

16. The method of claim 15, wherein coupling the breaker pick to the intermediate pick holder includes inserting a shank of the breaker pick in an opening of the intermediate pick holder and inserting a pin through a pin aperture to retain the breaker pick within the opening.

17. The method of claim 14, wherein inserting the shaft of the pick into the bore includes applying a force to a cutting end of the pick.
